(19) United States
(12) Patent Application Publication
(10) Pub. No.: US 2014/0146319 A1
(43) Pub. Date: May 29, 2014

(54) PRESENCE DETECTION SYSTEM AND A LIGHTING SYSTEM

(71) Applicants: Marieke Van Dooren, Arendonk (BE); Mark Thomas Johnson, Arendonk (BE); Giovanni Gennini, Eindhoven (NL)

(72) Inventors: Marieke Van Dooren, Arendonk (BE); Mark Thomas Johnson, Arendonk (BE); Giovanni Gennini, Eindhoven (NL)

(73) Assignee: KONINKLIJKE PHILIPS N.V., EINDHOVEN (NL)

(21) Appl. No.: 13/977,090

(22) PCT Filed: Dec. 29, 2011
(86) PCT No.: PCT/IB2011/056002

§ 371 Date: Jun. 28, 2013

(30) Foreign Application Priority Data
Jan. 4, 2011 (EP) 11150073.2

(51) Int. Cl. G01S 17/06

(52) U.S. Cl. CPC G01S 17/06
USPC 356/445

(57) ABSTRACT

A presence detection system for detecting presence of a living being (2) within an are (4), the system comprising a first light source (6a) providing light of a first spectrum, a first sensing means (8a; 10a) which is arranged to filter the light of the first spectrum. The first sensing means produces a first presence detection signal (12a) based on the light of the first spectrum originated form the first light source and reflected from the living being (2). The presence detection system comprises a processor device (14) for concluding the living being's presence within the area (4) based on the first presence detection signal (12a). The processor device provides a position (22a) of the living being (2) within the area based on the intensity of the first presence detection signal (12a) and based on the known position of the first light source (6a) within the area (4). The invention further relates to a lighting system comprising the above described presence detection system.

### FIELD OF THE INVENTION

The invention relates to a presence detection system for detecting presence of a person within an area. The system comprises a light source providing light and a sensing means which is arranged to produce a presence detection signal based on the light originated from the light source and reflected from the person. The system further comprises a processor device for concluding the person's presence within the area based on the presence detection signal.

The invention further relates to a lighting system comprising the above mentioned presence detection system.

### BACKGROUND OF THE INVENTION

An embodiment of such a system is disclosed in the patent application WO 97/26824. This patent application discloses an apparatus for monitoring a living body, for example a baby, involving transmitting radiation towards the body, receiving the radiation transmitted after modification by the body and processing the received radiation to determine the position and/or the state of the body, for example to determine if the body is breathing or its heart beating.

A drawback of the known system is the limited precision. Particularly, such a system is unable to precisely determine in which part of an area the living body is located.

### SUMMARY OF THE INVENTION

It is an object of the present invention to provide a presence detection system that is able to detect a presence and a position of a living being, for example a human or an animal, within an area. This object is achieved with the presence detection system according to the invention as defined in Claim 1. The presence detection system comprises a first light source providing light of a first spectrum, and a first sensing means, for example a sensor, sensitive to light of the first spectrum. The first sensing means produces a first presence detection signal based on the light of the first spectrum originated from the first light source and reflected from the living being. The presence detection system comprises a processor device for concluding the living being's presence within the area based on the first presence detection signal. The processor device provides a position of the living being within the area based on the intensity of the first presence detection signal and based on the known position of the first light source within the area. Differently from the apparatus known in the art, the presence detection system according to the invention is able to determine not only the living being's presence, but also the position of the living being within the area. The position of the living being is concluded by the processor device based on the intensity of the first presence detection signal. Thus, the system according to the invention does not have the above described problem of the known apparatus.

An embodiment of the presence detection system according to the invention has the feature that the presence detection system further comprises one additional sensing means, a second sensing means sensitive to light of the first spectrum. The second sensing means produces a second presence detection signal based on the light of the first spectrum originated from the first light source and reflected from the living being. The processor device concludes the living being's presence within the area based on the first presence detection signal and the second presence detection signal, wherein the processor device provides the position of the living being within the area based on the intensity of the presence detection signals and based on the known position of the light source within the area.

An embodiment of the presence detection system according to the invention has the feature that the presence detection system further comprises at least one additional light source, a second light source, for providing light of a second spectrum different from the first spectrum, and at least one additional sensing means, a second sensing means, which is arranged to filter the light of the second spectrum. The second sensing means produces a second presence detection signal based on the light of the second spectrum originated from the second light source and reflected from the living being. The processor device concludes the living being's presence within the area based on both, the first presence detection signal and the second presence detection signal or a subset thereof. The processor device provides the position of the living being within the area based on the intensity of the presence detection signals and based on the known position of the light sources within the area. Such a system provides additional advantage resulting in that the position of the living being is more precisely detected. The system with one light source and with one sensing means provides enough information about a distance of the living being in relation to the sensing means. Thus, the living being can be positioned in any point of the imaginary circle having the centre where the sensing means is located and having the radius equal to the detected distance. In the presence detection system with at least two light sources and with at least two corresponding sensing means the position of the living being is determined by the two intersection points of the two imaginary circles each originating from a different light source. The first sensing means and the second sensing means can be comprised by a single sensing means device. An example of such single sensing means device is an array of photodiodes, wherein each of the photodiodes is equipped with a corresponding filter.

An embodiment of the presence detection system according to the invention has the feature that the presence detection system further comprises at least one additional light source, a third light source, for providing light of a third spectrum different from the first spectrum and different from the second spectrum, and at least one additional sensing means, a third sensing means, which is arranged to filter the light of the third spectrum. The third sensing means produces a third presence detection signal based on the light of the third spectrum originated from the third light source and reflected from the living being. The processor device concludes the living being's presence within the area based on the first presence detection signal, the second presence detection signal and the third presence detection signal, or a subset thereof. The processor device provides the position of the living being within the area based on the intensity of the presence detection signals and based on the known position of the light sources within the area. The advantage of this embodiment in respect to the previous embodiment is that the third light source and the third sensing means unambiguously provide the position of the living being. While according to the previous embodiment the position of the living being was one of the two mentioned intersection points, the third light source and the third sensing means provide additional information which enables to conclude in which of the two mentioned points is the living being positioned.

An embodiment of the presence detection system according to the invention has the feature that each of said sensing means comprises a photodiode equipped with a filter, which filter is arranged to filter the light of the corresponding spectrum. The photodiode produces the presence detection signal based on the light of the corresponding spectrum originated from the corresponding light source and reflected from the living being.

An embodiment of the system according to the invention has the feature that each of the presence detection signals, which are produced by the sensing means of the system, comprises a vital sign of the living being, for example a heart rate, a heart rate variation or a breathing rate. An exemplary method to extract a vital sign from the presence detection signal can be to make use of a regular modulation of the intensity caused by the heart beat or respiration of the living being. Next to the temporal modulation of the intensity, also the average intensity can be used as a feature to obtain information about the position of the living being in the area. The processor device uses both features, the average intensity, for the position, and the temporal modulation of the intensity, for the vital sign, for concluding the living being's presence. Such a system, having the feature and functionality to extract a vital sign from the presence detection signal, gives additional security that the living being's presence is correctly concluded since, for example in case that the living being is a human, the known heart rate signal's parameters, in case that the vital sign is the heart rate signal, can be used as additional criteria when concluding the human's presence.

An embodiment of the system according to the invention has the feature that the presence signal represents the vital signals of at least two living beings present within the area. The processor device is able to distinguish between the respective vital signals of the at least two living beings.

The invention further relates to a lighting system comprising the above described presence detection system a light source for illuminating an area. The system is arranged for controlling the light source based on the presence detection.

### BRIEF DESCRIPTION OF THE DRAWINGS

In the following, the invention and further aspects will be described, by way of example, and explained hereinafter, using the following figures:

FIG. 1 schematically shows a first embodiment of a presence detection system according to the invention, wherein the system comprises one light source;

FIG. 2 schematically shows a second embodiment of a presence detection system according to the invention, wherein the system comprises two light sources;

FIG. 3 schematically shows a third embodiment of a presence detection system according to the invention, wherein the system comprises three light sources;

FIG. 4 schematically shows an absorption spectrum of the ohy-deoxyhemoglobin;

### DETAILED DESCRIPTION OF THE EMBODIMENTS

In the following description of the preferred embodiments, reference is made to the accompanying drawings which form a part thereof. Specific embodiments, in which the invention may be practiced, are shown in the following description by a way of illustration. It is also understood that other embodiments may be utilized and structural changes may be made without departing from the scope of the present invention. It is noted that the same reference signs will be used for indicating the same or similar parts in the several embodiments.

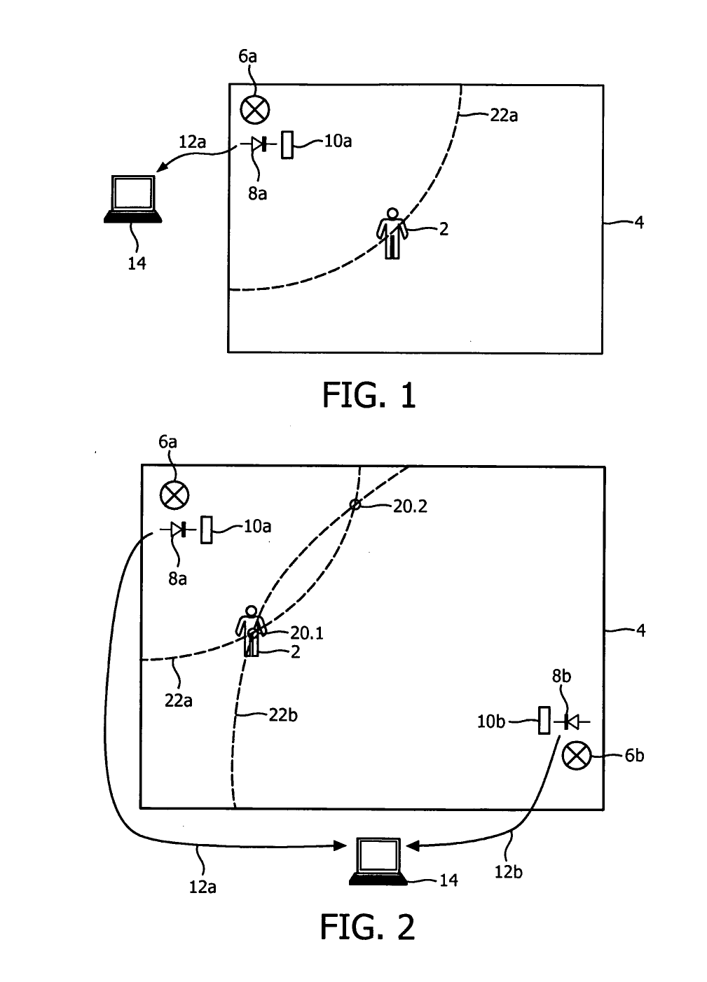

FIG. 1 schematically shows a first exemplary embodiment of the presence detection system for detecting presence of a living being 2 within an area 4 according to the invention. The living being can be a human or an animal and in this embodiment the system detects the presence of a human 2. In this embodiment, the system comprises a first light source 6a providing light of a first spectrum. The first spectrum can be from visible or non-visible light ranges. System further comprises a first sensing means 8a;10a which is arranged to filter the light of the first spectrum. The first sensing means can for example comprise a first photodiode 8a for detecting the light and a first filter 10a for filtering light of the first spectrum. Thus, only light of the first spectrum will pass the first filter and be detected by the first photodiode. Lights of spectra different from the first spectrum will not pass the first filter and consequently will not be detected by the first photodiode. The first sensing means produces a first presence detection signal 12a based on the light of the first spectrum originated from the first light source and reflected from the skin of the human 2. In the embodiment shown in FIG. 1, the first photo diode 8a will detect lights of the first spectrum reflected from the skin of the human 2. The presence detection system further comprises a processor device 14 for concluding the human's presence within the area 4 based on the first presence detection signal. The processor device provides a position 22a of the human 2 within the area based on the intensity of the first presence detection signal 12a and based on the known position of the first light source 6a within the area 4. Based on the first presence detection signal the processor device can conclude a distance of the human in respect to the first light source 6a. This is schematically shown in FIG. 1 by a part of the circular line 22a. Thus, the processor device concludes that the human is positioned in a point of the line 22a. In this way, not only that the human's presence is detected, but additionally an indication of the position of the human is provided.

FIG. 2 schematically shows a second exemplary embodiment of the presence detection system. It has all elements of the first embodiment as described above and as shown in FIG. 1. The system further comprises at least one additional light source, a second light source 6b, for proving light of a second spectrum different from the first spectrum. The system also comprises at least one additional sensing means, a second sensing means 8b; 10b which is arranged to filter the light of the second spectrum. Similarly to the first sensing means, the second can comprise a second photodiode 8b and a second filter 10b. The second photodiode 8b produces a second presence detection signal 12b based on the light of the second spectrum originated from the second light source 6b and reflected from the skin of the living being (2). Compared to the first embodiment according to FIG. 1, the second embodiment according to FIG. 2 provides the processor device 14 with an additional signal, the second presence detection signal. Thus, the processor device concludes the human's presence within the area 4 based on both the first presence detection signal 12a and the second presence detection signal 12b, or a subset thereof. The processor device provides the position 20.1;20.2 of the human 2 within the area based on the intensity of the presence detection signals 12a; 12b and based on the known position of the light sources 6a;6b within the area 4.

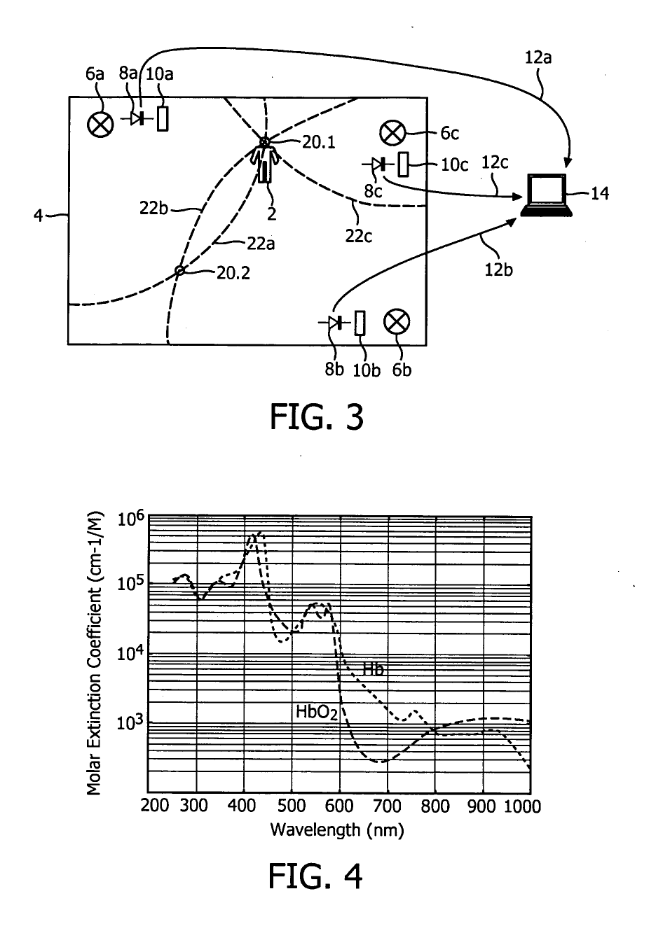

Such a system provides additional advantage in comparison to the first embodiment resulting in that the position of the human is less ambiguously determined. In the system with two light sources according to the second embodiment, the position of the living being is determined by the two intersection points of the two imaginary circles 22a;22b. A third embodiment considers adding a further light source and sensing means. The additional light source, the third light source 6c, according to this embodiment provides the exact position of the living being. In the concrete example shown in FIG. 3 the third sensing means detects the living being in point 20.1. All three sensing means, the first sensing means, the second sensing means and the third sensing means can be comprised by a single sensing means device.

Further advantageous embodiments of the invention comprise systems with more sensing means than light sources. The system comprises all elements of the first embodiment as described above and as shown in FIG. 1. The system further comprises at least one additional sensing means, a second sensing means which is also arranged to filter the light of the first spectrum. Similarly to the first sensing means, the second can comprise a second photodiode and a second filter, which may be identical to the first filter. The second photodiode produces a second presence detection signal based on the light of the first spectrum originated from the first light source and reflected from the living being, however the signal will be different as the second sensing means is positioned at a different position compared to the living being than the first sensing means. Compared to the first embodiment according to FIG. 1, according to this embodiment the processor device is provided with an additional signal, the second presence detection signal. Thus, the processor device concludes the human's presence within the area based on both the first presence detection signal and the second presence detection signal. The processor device provides the position of the human within the area based on the intensity of the presence detection signals and based on the known position of the light source and the sensing means within the area.

As already mentioned, in case that the living being is a person 2, a photodiode 8a;8b;8c is capable to dynamically measure the heart rate, heart rate variability, blood oxygenation and possibly blood pressure from the person. The result of such a measurement is comprised by the presence detection signal 12a; 12b; 12c.

The system according to the previous embodiments can be provided by a look-up table. The table describes a map of the area represented by e.g. a series of position co-ordinates and a list having the relation between the distance of the living being from the light source and the intensity of the presence detection signal. The presence detection signal comprises both the positional information, in the form of the average light intensity, and the vital signs information, in the form of a regular modulation of the intensity (in time) caused by the heart beat or respiration. The look-up table preferably contains the positional information. The table may contain the absolute light intensities that correspond to the relevant spatial positions in the area. However, in a preferred embodiment, the table should contain the relative light intensities that correspond to the different spatial positions in the area. In this case, the position of the human will be derived by comparing the relative intensities of the presence detection signals, as being measured by the sensing means, with the associated values which are stored in the look-up table. Having such a list would help the processor device in respect to concluding the presence. Instead of developing software to calculate said distance the processor device needs only to take the relevant information from the predetermined list. However, creation of such list should be done in advance.

The light sources can have the light spectrum in both visible and non visible range. Thus, a spectral bandwidth of the light sources and the adequate sensing means, for example the photodiode array equipped with the adequate filters, can fall outside the visible light wavelengths, i.e. the wavelengths between 400 nm and 700 nm.

FIG. 4 shows the absorption spectrum of the oxhyhemoglobin (HbO2) and deoxyhemoglobin (Hb) used for the measurement of the heart rate of the human. It is clear from FIG. 4 that measurement of the heart rate is possible using the light from a very broad range, at least from 200 to 1000 nanometres (nm).

Referring to FIG. 4, it is apparent that light is strongly absorbed by the blood flow in the person's skin at both ultraviolet (UV) frequencies, i.e. below 400 nm, and at infrared (IR) frequencies, i.e. above 700 nm. As the effect of UV light can be damaging for the skin, it is preferred that the spectral frequencies which are used are IR frequencies where the light is still strongly absorbed by the blood flow in the skin. These are typically frequencies between 700 nm and 1200 nm.

Such an IR based spectrum is suited as both IR light sources, e.g. LED, and photodiodes are readily available across the entire IR wavelength range. FIG. 4 additionally shows that within the wavelength range from around 250 nm to around 1000 nm the light is strongly absorbed by the blood flow in the human's skin. As already said in the previous text that range corresponds to the ultraviolet spectrum, the infrared spectrum and the visible spectrum.

If the photodiode array is used, a one-time calibration of the system may be required in order to translate the spectral colour detected by the photodiode array into a spatial co-ordinate. However, if the illumination pattern is fixed and optionally matched 1:1 to the filters of the photo sensor, the calibration problem will be trivial.

The light sources can use light of non-visible wavelengths since it is not always desirable to illuminate the space with coloured lighting. For this reason, a preferred embodiment of the invention proposes to construct the system whereby the spectrum bandwidth of the light source and the photosensor array filter fall outside the visible light wavelengths, i.e. 350-700 nanometres (nm).

The light is also strongly absorbed by the blood flow in the human's skin at both infrared (IR) wavelengths, above 700 nm, and at ultraviolet (UV) wavelengths, below 400 nm, as it is shown in FIG. 4. As the effect of UV light can be damaging for the skin, it is highly preferred that the spectrum frequencies which are used are IR frequencies where the light is still strongly absorbed by the blood flow in the skin. Such an IR based spectrum is highly suited as both IR light sources, for example LEDs, and photodiodes are readily available across the entire IR wavelength range.

In some embodiments, the sensing means comprise photo sensors having different spectral sensitivities. Such photo sensors sensitive to light of the predefined spectrum can be used instead of the photo sensor equipped with the spectral filter for filtering the light of predefined spectra. In some embodiments, the photo sensors may have intrinsically different spectral sensitivities, whereby they can intrinsically distinguish between light of the different predefined spectra. The intrinsically different spectral sensitivities may be realised by e.g. using different classes of photo sensors such as photodiodes, CCDs, photomultipliers etc. Alternatively the intrinsically different spectral sensitivities may be realised using photo sensors of the same class, such as photodiodes, with different material properties e.g. silicon (Si) based or Gallium Arsenide (GaAs) based; different doping levels in Si etc. Alternatively the different spectral sensitivities can be realised by adding spectral filters.

The invention also proposes specific concepts whereby either the spectral bandwidth of the light source or the photodiode array filter is reduced. In general, the bandwidth of the light source should fall within the bandwidth of the photodiode array filter.

Furthermore, such a system may comprise a discrete or continuous light spectrum. It will be apparent to those experienced in the art that such a system may be created by using a broadband light spectrum or a series of light sources with reduced bandwidth spectrum, or with single frequency light sources, such as lasers and LEDs. Furthermore, it is also possible that each photodiode in the array has a discrete filter.

A further aspect of the invention is a method to determine the spatial position of the living being in the area. The method comprises the performance of a calibration phase to connect the relevant spatial co-ordinates to the corresponding absolute or relative intensities of the presence detection signals. In this manner the look-up table can be created.

There are different approaches to such a calibration method to provide a co-ordinate system Two possibilities are described in the following text.

A first embodiment of the method is based upon the use of a picture of the space with the light source or sources. The picture provides a map of the space with the spectral illumination at different spatial locations.

A second embodiment of the method is based upon a calibration phase where the reflection of the one or more lights on the skin of a person is measured at different locations. When a person is present in the illuminated space, the light from their skin will reflect the position in the space.

Both approaches result in a look-up table where the position in the space is related to a specific reflected signal.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

### LIST OF REFERENCE NUMERALS

2 a living being
4 an area
6a;6b;6c a light source
8a;8b;8c a photodiode
10a; 10b; 10c a filter
12a; 12b; 12c a presence detection system
14 a processor device
20.1;20.2 a position
22a;22b;22c a position line

1. A presence detection system for detecting presence of a living being within an area, wherein the system comprises;
a first light source providing light of a first spectrum having a known position within the area;
a first sensing means sensitive to light of the first spectrum, wherein the first sensing means produces a first presence detection signal based on the light of the first spectrum originated from the first light source and reflected from a skin of the living being and
a processor device configured to detect the living being's presence within the area based on the first presence detection signal wherein the processor device provides a position of the living being within the area based on an intensity of the first presence detection signal and based on the known position of the first light source within the area.

2. The presence detection system as claimed in claim 1, further comprising at least one-additional sensing means, comprising a second sensing means sensitive to light of the first spectrum, wherein the second sensing means produces a second presence detection signal based on the light of the first spectrum originated from the first light source and reflected from the skin of the living being, wherein the processor device is configured to detect the living being's presence within the area based on the first presence detection signal and the second presence detection signal, wherein the processor device determines the position of the living being within the area based on intensity of the at least one of the first and the second presence detection signals and based on the known position of the first light source within the area.

3. The presence detection system as claimed in claim 1, wherein the system comprises:
at least one additional light source, comprising a second light source having a known position, for providing light of a second spectrum different from the first spectrum, and
at least one-additional sensing means, comprising a second sensing means sensitive to light of the second spectrum, wherein the second sensing means produces a second presence detection signal based on the light of the second spectrum originated from the second light source and reflected from the skin of the living being,
wherein the processor device is configured to detect the living being's presence within the area based on the first presence detection signal and the second presence detection signal, wherein the processor device is configured to determine the position of the living being within the area based on intensity of the at least one of the first and the second presence detection signals and based on the known position of the any of the first, and second light sources within the area.

4. The presence detection system as claimed in claim 3, wherein the system comprises:
at least one additional light source, comprising a third light source having a known position, for providing light of a third spectrum different from the first spectrum and different from the second spectrum, and
at least one additional sensing means, comprising a third sensing means, sensitive to light of the third spectrum, wherein the third sensing means produces a third presence detection signal based on the light of the third spectrum originated from the third light source and reflected from the skin of the living being,
wherein the processor device is configured to detect the living being's presence within the area based on at least one of the first presence detection signal, the second presence detection signal and the third presence detection signal, wherein the processor device provides the position of the living being within the area based on intensity of the at least one of the first, second and third presence detection signals and based on the known position of the at least one of the first, second and third light sources within the area.

5. The presence detection system as claimed in claim 4, wherein each of the first, second, and third sensing means comprises a photodiode equipped with a filter which is configured to filter the light of corresponding spectrum, wherein the photodiode produces a corresponding presence detection signal based on the light of the corresponding spectrum originated from a corresponding light source and reflected from the skin of the living being.

6. The presence detection system as claimed in claim 4, wherein any of the first, second, and third the presence detection signals comprise a vital signal of the living being, comprising any of a heart rate, a heart rate variation or a breathing rate, wherein the processor device uses, at least one of the first, second, and third presence detection signals and the vital signal for detecting the living being's presence.

7. The presence detection system as claimed in claim 6, wherein any of the first, second, and third presence detection signal comprise vital signals of at least two living being's present within the area and wherein the processor device distinguishes between the respective vital signals of the at least two living beings.

8. A lighting system, comprising:
a presence detection system for detecting presence of a living being within an area, the system comprising:
a first light source providing light of a first spectrum having a known position within the area;
a first sensing means sensitive to light of the first spectrum, wherein the first sensing means produces a first presence detection signal based on the light of the first spectrum originated from the first light, source and reflected from a skin of the living being; and
a processor device configured to detect the living being's presence within the area based on the first presence detection signal, wherein the processor device provides a position of the living being within the area based on an intensity of the first presence detection signal and based on the known position of the first light source within the area; and
a light source for illuminating the area, wherein the Illumination system is configured to control the light, source based on the presence detection of the living being in the area.

9. A method of detecting presence of a living being within an area using a presence detection system, the method comprising:
providing light of a first spectrum using a first light source having a known position within the area;
producing a first presence detection signal by a first sensing means, having sensitivity to light of the first spectrum, based on the light of the first spectrum originated from the first light source and reflected from a skin of the living being; and
detecting, by a processor device, the living being's presence within the area based on the first presence detection signal; and
providing, by the processor device, a position of the living being within the area based on an intensity of the first presence detection signal and based on the known position of the first light source within the area.

10. The method of claim 9, further comprising:
producing a second presence detection signal, using at least one-additional sensing means, comprising a second sensing means, based on the light of the first spectrum originated from the first light source and reflected from the skin of the living being, wherein the second sensing means is sensitive to light of the first spectrum; and
detecting, using the processor device, the living being's presence within the area based on the first presence detection signal and the second presence detection signal;
determining, by the processor device, the position of the living being within the area based on intensity of the at least one of the first and the second presence detection signals and based on the known position of the first light source within the area.

12. The method of claim 9, further comprising:
providing light of a second spectrum different from the first spectrum, using at least one additional light source, comprising a second light source having a known position;
producing a second presence detection signal based on the light of the second spectrum originated from the second light source and reflected from the skin of the living being, using at least one-additional sensing means, comprising a second sensing means sensitive to light of the second spectrum;
detecting, using the processor device, the living being's presence within the area based on the first presence detection signal and the second presence defection signal; and
determining, using the processor device, the position of the living being within the area based on intensity of the at least one of the first and the second presence detection signals and based on the known position of the any of the first and second light sources within the area.

13. The method of claim 12, further comprising:
providing light of a third spectrum different from the first spectrum and different from the second spectrum, using at least one additional light source, comprising a third light source having a known position;
producing a third presence detection signal based on the light of the third spectrum originated from the third light source and reflected from the skin of the living being, using at least one additional sensing means, comprising a third sensing means, sensitive to light of the third spectrum;
detecting, using the processor device, the living being's presence within the area based on at least one of the first presence detection signal, the second presence detection signal and the third presence detection signal; and
providing, using the processor device, the position of the living being within the area based on intensity of the at least one of the first, second and third presence detection signals and based on the known position of the at least one of the first, second and third light sources within the area,

14. The method of claim 13, wherein each of the first, second, and third sensing means comprises a photodiode equipped with a filter configured to filter the light of a corresponding spectrum, the method further comprises producing a corresponding presence detection signal based on the light of the corresponding spectrum originated from a corresponding light source and reflected from the skin of the living being.

15. The method of claim 13, wherein any of the first, second, and third the presence detection signals comprise a vital signal of the living being, comprising any of a heart rate, a heart rate variation or a breathing rate, wherein the method further comprises detecting, using the processor device, the living being's presence using at least one of the first, second, and third presence detection signals and the vital signal.

16. The method of claim 15, wherein any of the first, second, and third presence detection signal comprise vital signals of at least two living being's present within the area, and wherein the method further comprises detecting and distinguishing, using the processor device, between the respective vital signals of the at least two living beings.
